(19) United States
(12) Patent Application Publication
(10) Pub. No.: US 2024/0342789 A1
(43) Pub. Date: Oct. 17, 2024

(54) Method for maintenance of a sliding closure at the outlet of a metallurgical vessel

(71) Applicant: Refractory Intellectual Property GmbH & Co. KG, Wien (AT)

(72) Inventors: Beat Heinrich, Zurich (CH); Jean-Daniel Cousin, Luzern (CH); Robert Hein Loedeman, Rickenbach (CH)

(73) Assignee: Refractory Intellectual Property GmbH & Co. KG, Wien (AT)

(21) Appl. No.: 18/749,247

(22) Filed: Jun. 20, 2024

Related U.S. Application Data
(62) Division of application No. 17/271,798, filed on Feb. 26, 2021, now Pat. No. 12,070,796.

(30) Foreign Application Priority Data
Sep. 4, 2018 (CH) 01051/18

(51) Int. Cl. B22D 41/34; B25J 11/00

(52) U.S. Cl. CPC B22D 41/34; B25J 11/00

(57) ABSTRACT

Method for servicing or maintenance of a sliding closure on an outlet of a metallurgical vessel includes controlling, using a robot for automated maintenance, a drive on the sliding closure to selectively enable release of the sliding closure or drive, and enable unfolding of the sliding closure. When the sliding closure is unfolded, a first refractory closure plate is, together with a first cassette, insertable into or removable from a housing of the sliding closure and a second refractory closure plate is, together with a second cassette, insertable into or removable from a slider unit coupled to the housing. In an available manual maintenance stage at the same location, the cassettes are fixed in the housing and slider unit and the closure plates are insertable manually directly into the respective cassette to be centered and fastened therein, or the closure plates are releasable from the respective cassette.

### FIELD OF THE INVENTION

The invention relates to a method for servicing or maintenance of a sliding closure at the outlet or spout of a metallurgical vessel including a sliding closure.

### BACKGROUND OF THE INVENTION

With a known method according to the published document EP-2 056 983, corresponding to U.S. Pat. No. 8,498,740, a method and/or an installation is disclosed of a sliding closure mounted at the outlet of a vessel for molten metal. This installation is provided with at least one tool magazine, at least one spare part magazine and with means for opening and closing the sliding closure. For this purpose, a robot provided with an automatic grip changing system and a control system is available, which, firstly, is capable of automatically detecting the precise position of the vessel or the sliding closure. It can then actuate the means for opening and closing the sliding closure and, depending on the condition of the individual components that might require replacement, can take tools and/or spare parts from the magazines surrounding it and carry out cleaning operations, component removal and replacement or reinstallation.

### OBJECTS AND SUMMARY OF THE INVENTION

On this basis, the task forming the basis of the present invention has been to further develop a method for maintenance operation of the type described above that is optimally adapted to the harsh operating conditions in the steelworks and, in particular, to the ladle area.

This problem is solved according to the invention in accordance with a method for servicing or maintenance of a sliding closure on an outlet of a metallurgical vessel including, but not limited to, controlling, using a robot for automated maintenance, a drive on the sliding closure to selectively enable release of the sliding closure or release of the drive by disengaging fastening means, and enable unfolding of the sliding closure. When the sliding closure is unfolded or swung out or open, a first refractory closure plate is, together with a first cassette, insertable into or removable from a housing of the sliding closure and a second refractory closure plate is, together with a second cassette, insertable into or removable from a slider unit of the sliding closure coupled to the housing. A manual maintenance state is provided at the location at which the sliding closure is maintained and in which the first and second cassettes are fixed respectively in the housing and the slider unit and the first and second closure plates are insertable manually directly into the respective one of the first and second cassettes when present in the sliding closure to be centered and fastened therein, or the first and second closure plates are releasable from the respective one of the first and second cassettes.

With the method for maintenance of a sliding closure at the outlet of a metallurgical vessel in accordance with the invention, this can be changed from automated maintenance with the robot to manual maintenance of the sliding closure and vice versa, in part carrying out different operations.

Consequently, according to the circumstances at the maintenance location, it is very simple to change from automated to manual maintenance and thereby the operations for a plate replacement or for monitoring can be carried out in one or the other maintenance operation rationally and successfully.

It is very advantageous for automated maintenance for the closure plates to be kept together with a cassette in the housing and inserted in the slider unit and/or removed from this; in manual maintenance operation, however, these cassettes are fixed in the housing or preferably also in the sliding unit and the closure plates are manually inserted directly into these cassettes and centered therein or fastened or released.

With sliding units according to the invention, a cassette is kept in the housing and/or in the slider unit to receive a closure plate, which can be fixed therein or released, respectively by automatically lockable or releasable connecting means.

Preferably, for these connecting means for the removable cassettes at each end side at least one retaining means is provided and, opposite, at least one elbow lever mechanism with, corresponding recesses at one end and snap-in elements at the other. With this configuration of the cassettes, the same can be directly inserted or removed in automated maintenance without additional functions.

### BRIEF DESCRIPTION OF THE DRAWINGS

The invention together with further advantages of the same are explained in the following in more detail with the aid of exemplary embodiments by reference to the drawings wherein:

FIG. 1 is a perspective view of a sliding closure in accordance with the invention in an unfolded state;

FIG. 2 is a longitudinal section of the housing and the cassette of the sliding closure according to FIG. 1 as the cassette is being pushed into the housing;

FIG. 3 is the longitudinal section of FIG. 2 with the cassette pushed into the housing and in fixed position;

FIG. 4 is a longitudinal section of the sliding closure and the cassette of the sliding closure according to FIG. 1 during pushing of the cassette into the slider unit;

FIG. 5 is an enlarged section of the elbow lever mechanism during pushing of the cassette according to FIG. 2;

FIG. 6 is the enlarged view of the elbow lever mechanism after the cassette has been pushed in as in FIG. 3;

FIG. 7 is a plan view on the partially shown cassette with the clamping module for clamping a closure plate in the released state; and

FIG. 8 is the plan view of FIG. 7 with the clamping module in the clamped state.

### DETAILED DESCRIPTION OF THE INVENTION

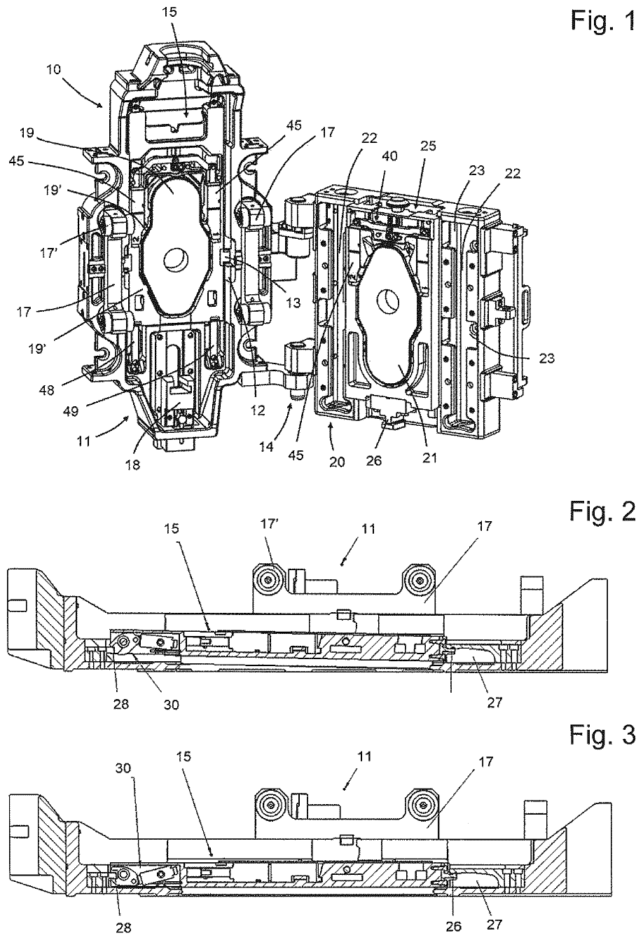

The sliding closure 10 according to FIG. 1 essentially consists of a housing 11 which can be fastened to a vessel and a slider unit 20 pivotably linked to this by means of a hinge 14, which is shown in an unfolded open position. A refractory closure plate 19, 21 is respectively clamped in the housing 11 and in the slider unit 20 and are pressed together in the closed state of the sliding closure.

Such a sliding closure 10 is itself manufactured in a conventional manner and this is suitable preferably for a ladle containing molten steel for pouring in a continuous casting plant. However, the sliding closure could be used with other vessels, for example with a converter or a distributor or perhaps with furnaces in the non-ferrous metals sector.

In the housing 11, on either side of the closure plate 19 a perpendicular retaining means 17 is arranged with rollers 17′ on the inside and outside, which in the folded state slide on ramp-like guide tracks, not shown in more detail, of T-groove shaped recesses 22 in the slider unit 20. These recesses 22 are provided with widening openings 23, through which the rollers 17′ are inserted or released. Therewith, the slider unit 20 is guided longitudinally on the housing 11 by a drive, not shown, usually by a piston/cylinder unit attached to the housing 11, of which the connectable coupling parts 18, 26 with the housing 11 or with the slider unit 20 are shown.

During pivoting of the slider unit 20, this is moved longitudinally relative to the housing 11 by the drive, through the guidance of the rollers 17′ on the ramp-like guide tracks, into these recesses 22 and thereby the closure plates 19, 21 are clamped against one another and conversely released again.

On the mode of functioning of this sliding closure 10 in more detail, reference is made to the document EP 1 119 428, in which the details of the interaction of the retaining means with the slider unit are explained at length.

According to the invention, a metallic cassette 15, 25 is contained in the each of the housing 11 and the slider unit 20 to receive the closure plates 19, 21, which can be respectively fixed therein or released by automatically lockable or releasable connecting means.

In the cassettes 15, 25, clamping modules 45 extending on either side of the closure plates 19, 21 are each associated with a clamping device 40, by means of which the closure plates 19, 21 with their four external sloping surfaces 19′ can be fixedly clamped, as is explained in detail in the following.

Furthermore, centering elements 13 and their corresponding guide elements 12 are arranged laterally of the cassette 15 or in the housing 11. Thus, the cassette 15 is precentered during introduction into the housing 11 and the centering elements 13 effect a fixation of the same in the displacement direction of the slider unit 20, in order to accommodate the resulting displacement forces in the clamped state of the plates.

According to FIGS. 2 and 3, cams 26 are provided as connection means for the cassette 15, insertable in the housing 11 on the narrower end side as retaining elements, and opposite preferably two elbow lever mechanisms 30 positioned parallel to one another, while corresponding recesses 27 are provided in the housing 11 with spring retaining elements 48, 49 on one side and snap-action elements 28 (also referred to as snap-in elements herein) on the other.

As can be seen in FIG. 2, the cassette 15 is introduced at an angle into the housing 11, until its cams 26 at one end of the cassette are inserted precisely into this recess 27 in the housing 11 and, as a consequence of the pressure, the cassette 15 is fixed in the housing 11 without play through the snap-in element 28 by engagement with the elbow lever mechanism 30, as shown in FIG. 3.

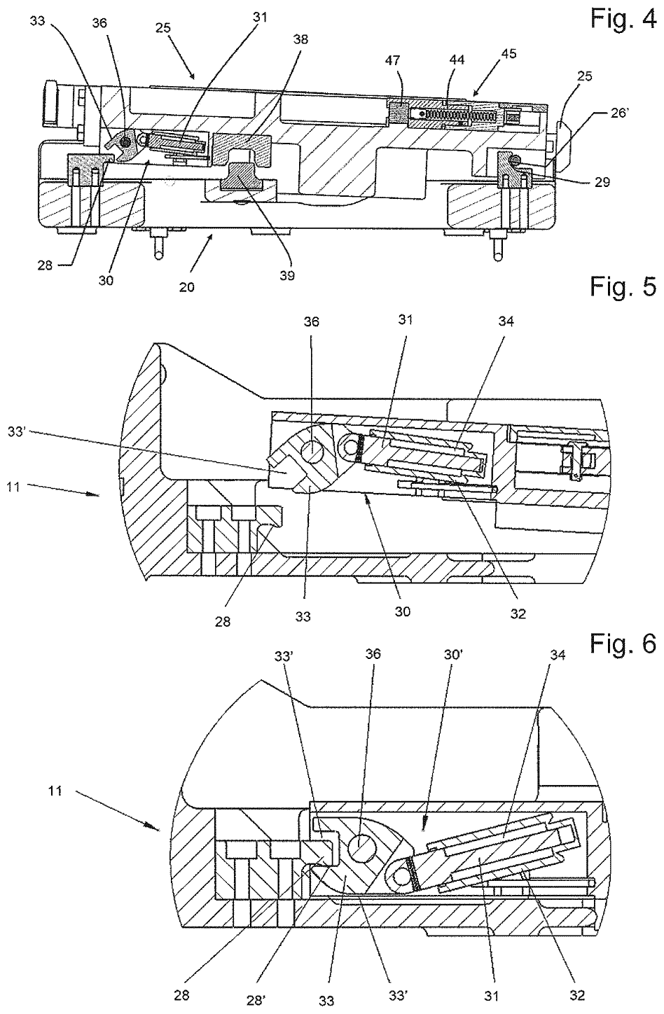

According to FIG. 4, as connecting elements for the cassette 25 insertable into the slider unit 20, pins 26′ are arranged as retaining elements on the narrower end and similarly, opposite them, two parallel elbow lever mechanisms 30, while the stops 29 (also referred to as abutments herein) corresponding to the slider unit 20 are provided as retaining elements on one side and the snap-in elements 28 on the other side. In addition, the cassette 25 is centered by means of centering elements 38 in corresponding guide elements 39 and is held in the displacement direction, so that the cassette also cannot move therein with back and forth movement of the slider unit.

The cassette 25 is inserted into the slider unit 20 almost obliquely, until its pins 26′ engage these stops 29 at one end of the slider unit, and as a consequence of the pressure, the cassette is fixed therein without play though the latching elbow lever mechanism 30 with the snap-in element 28.

The respective elbow lever mechanism 30 with the cassettes 15, 25, is shown in an enlarged view in FIG. 5 and FIG. 6, of a spring-loaded lever 31 hinged in the cassette 15, 25 and a snapper 33 rotatably attached to this, mounted pivotably on the cassette 15, 25 by means of a spindle 36. The lever 31 has limited adjustment in its longitudinal direction with a compression spring 34 in a sleeve 32 and, except in the dead center, the lever 31 produces with it a continuously acting torque against the snapper 33.

In the released state according to FIG. 5, the snapper 33 is directed with aperture 33′ against the direction of pressure of the cassette. With further pressure, this snapper 33 with its aperture 33′ comes into contact with the snap-in element 28 and is then rotated until it rests with its underside 33″ on the housing 11 or the slider unit 20. Thus, the lever 31 engaging the snap-in element 33, after passing through the dead point, effects a torque through the compression spring 34 on this snapper 33, until the same rests on a lower support 28′ of the snap-in element 28 and thus the retention of the cassette is assured.

Removal of the cassette 15, 25, is effected by a specific tensile force on the same, approximately perpendicularly away from the housing 11 or from the slider unit 20, so that the elbow lever mechanism 30 is turned by the resultant torque on the snapper 33 at the lower support 28′ in the direction towards the open position, as shown in FIG. 5. This also enables the cassettes 15, 25 to be released automatically.

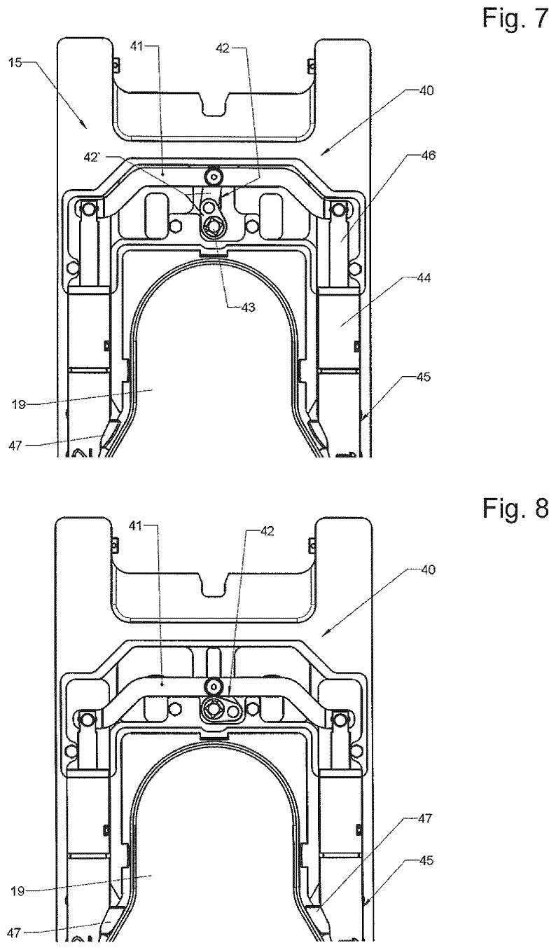

FIG. 7 and FIG. 8 show, in the context of the invention, a clamping device 40 capable of clamping the closure plate 19, in a cassette 15, which is composed of an adjustment clip 41, clamping modules 45 either side of the closure plate 19, with push rods 46 and wedges 47 as well as an elbow lever linkage 42. The clamping modules 45 are incorporated in the cassette 15 and each has a spring member 44, which is connected with a respective push rod 46 and acts so that in the braced state a spring pressure is produced in the stressing direction, as can also be seen in FIG. 4. This elbow lever linkage 42 consists of two levers 42′, which are connected to the adjustment clip 41, the cassette 15, and to each other. The one lever 42′ has a square opening or similar, into which a turnkey can inserted and can be turned by hand and thus enable opening or closing of the clamping device.

This clamping device 40 is shown in FIG. 7 in the open position, in which the wedges 47 adjustable with the push rods 46 are withdrawn and thus the closure plate is insertable or withdrawable. The two levers 42′ are rotated beyond the dead center and act together with the spring pressure, so that the adjustment clip 41 remains in the open position.

By turning in the opposite direction, the adjustment clip and with it the push rods 46 and also the wedges 47 are moved in the direction of the closure plate and then clamping of the plate 19 is enabled, as shown in FIG. 8.

With the cassette 25 that can be inserted into the slider unit 20 a similar clamping device 40 is provided for clamping the closure plate provided as for a slide plate, as described above with the other cassette 15.

The sliding closure 10 described in detail above is suitable for an automated maintenance by a robot, not shown in more detail, at a maintenance location, as explained in detail and illustrated in the document EP 2 056 983 mentioned at the beginning. This vessel provided as ladle, after emptying of the metal melt, is located at the maintenance area, roughly in a horizontal position, so that the sliding closure mounted at its outlet is on its side and thus is easily accessible for this maintenance that is often required.

With a detection system that can be mounted on the robot, the precise position of the vessel and the sliding closure 10 at the maintenance area can be determined. Following the determination or recognition of the precise position of the vessel and the sliding closure 10, a drive can be mounted on the sliding closure and connected to a pressure source, with which the sliding closure 10 can be released and the slider unit 20 can be swung out (unfolded), as can be seen in FIG. 1. Thereafter the robot can at times insert a refractory closure plate 19, 21 in the slider unit 20, or in the housing 11, respectively, or can remove the refractory closure plates 19, 21 from the slider unit 20 or housing 11, respectively.

According to a method in accordance with the invention, the automated maintenance with the robot can be changed over to a manual maintenance of the sliding closure 10 at the maintenance area or the reverse, where different working steps take place when automated maintenance becomes manual maintenance.

During automated maintenance, the closure plates 19, 21, together with the metal cassettes 15, 25 in which they are situated respectively, are grasped by the robot from a magazine and correspondingly inserted into the housing 11 and into the slider unit 20, or are removed from them, while conversely, during manual maintenance operation, these cassettes 15, 25 are fixed in the housing 11 or in the slider unit 20, respectively, and the closure plates 19, 21 are inserted manually directly into these cassettes 15, 25 and centered therein or fastened or respectively released.

Advantageously, moreover, the mounting, not shown, for the drive with the coupling part 18 for the housing 11 is positioned on the opposite side for automated maintenance to that for manual maintenance, for simpler manipulation.

However, within the context of the invention, the maintenance of the sliding closure 10 can also take place in a mixed operation, with part manual and part automated operation stages. For example, the drive can be installed by robot and also the closure plates in the cassettes can be changed by the robot, while manual cleaning operations or the plates can be inspected for their condition after pouring.

The invention is adequately demonstrated with the above exemplary embodiment. However, it could obviously be implemented by other variants. Thus, these automatically lockable or releasable connection means for the cassettes can be implemented instead of the elbow lever mechanism by a door latch system or a snap-in mechanism with a compressible bent spring or similar.

Likewise, these connecting means could be arranged so that, for example, the elbow lever mechanism would be contained inverted in the housing or in the slider unit and the corresponding recesses and snap-in elements would be available in the respective cassette. In addition, retaining means could be provided, which would be positioned along the longitudinal side of the cassettes and the housing of the slider unit, for example as snap-in elements.

In principle, only one interchangeable cassette could be provided in the housing, while the slider unit would be removed as a whole by the robot or suspended again by means of hinges located on the housing.

The sliding closure could also be configured so that, instead of a housing and a slider unit mounted displaceably on it, an additional slider cover could be provided, which would be fastenable on the housing by attachment means. With an automated operation, the robot could tighten or release these fastening means with a suitable operating unit.

1. Method for maintenance of a sliding closure on an outlet of a metallurgical vessel, comprising:
controlling, using a robot for automated maintenance, a drive on the sliding closure to selectively enable release of the sliding closure or release of the drive by disengaging fastening means, and enable unfolding of the sliding closure, wherein when the sliding closure is unfolded, a first refractory closure plate is, together with a first cassette, insertable into or removable from a housing of the sliding closure and a second refractory closure plate is, together with a second cassette, insertable into or removable from a slider unit of the sliding closure coupled to the housing; and
providing a manual maintenance stage at the location at which the sliding closure is maintained and in which the first and second cassettes are fixed respectively in the housing and the slider unit and the first and second closure plates are insertable manually directly into the respective one of the first and second cassettes when present in the sliding closure to be centered and fastened therein, or the first and second closure plates are releasable from the respective one of the first and second cassettes.

2. The method of claim 1, further comprising switching between the automated maintenance and the manual maintenance stage during a common maintenance operation on the sliding closure.

3. The method of claim 1, further comprising, during the automated maintenance, gripping the first and second cassettes with the first and second closure plates respectively situated therein using the robot.

4. The method of claim 3, further comprising, during the automated maintenance, pushing the first and second cassettes with the first and second closure plates respectively situated therein when gripped by the robot into the housing and the slider unit, respectively.

5. The method of claim 4, further comprising, during the automated maintenance, automatically locking the first and second cassettes in the housing and the slider unit, respectively, after having been pushed with the first and second closure plates respectively situated therein into the housing and the slider unit, respectively.

6. The method of claim 5, further comprising, during the automated maintenance, automatically releasing the locking of the first and second cassettes in the housing and the slider unit, respectively.

7. The method of claim 6, further comprising, during the automated maintenance after the release of the locking of the first and second cassettes in the housing and the slider unit, respectively, withdrawing the first and second cassettes from the housing and the slider unit, respectively, using the robot.

8. The method of claim 4, further comprising, during the automated maintenance, locking the first and second cassettes in the housing and the slider unit, respectively, after having been pushed with the first and second closure plates respectively situated therein into the housing and the slider unit, respectively.

9. The method of claim 8, further comprising, during the automated maintenance, releasing the locking of the first and second cassettes in the housing and the slider unit, respectively.

10. The method of claim 9, further comprising, during the automated maintenance after the release of the locking of the first and second cassettes in the housing and the slider unit, respectively, withdrawing the first and second cassettes from the housing and the slider unit, respectively, using the robot.

11. The method of claim 1, further comprising:
providing centering elements in corresponding guide elements laterally to the housing and retained in a displacement direction;
centering the first cassette by means of the centering elements.

12. The method of claim 1, further comprising, when performing maintenance of the sliding closure, performing both the automated maintenance and the manual maintenance in a mixed operation with work steps partly manual and partly automated.

13. The method of claim 1, further comprising, prior to performing the automated maintenance, determining using the robot, a precise position of the vessel and the sliding closure at the location at which the sliding closure is maintained.

14. The method of claim 13, further comprising mounting the drive on the sliding closure after the precise position of the vessel and the sliding closure have been determined.

15. The method of claim 1, further comprising controlling the robot to grasp the first and second cassettes having the first and second closure plates respectively therein from a magazine in preparation for insertion of the first and second cassettes into the housing and slider unit respectively.

16. The method of claim 1, further comprising coupling the drive to a pressure source to enable, through use of the pressure source, release of the sliding closure and thus swinging of the slider unit relative to the housing.

17. The method of claim 1, further comprising, during the automated maintenance:
gripping the first cassette with the first closure plate situated therein using the robot; then
pushing the first cassette with the first closure plate situated therein into the housing; and then
locking the first cassette in the housing.

18. The method of claim 17, further comprising, during the automated maintenance:
releasing the locking of the first cassette in the housing; and then
withdrawing the first cassette from the housing using the robot.

19. The method of claim 1, further comprising, during the automated maintenance:
gripping the second cassette with the second closure plate situated therein using the robot; then
pushing the second cassette with the second closure plate situated therein into the slider unit; and then
locking the second cassette in the slider unit.

20. The method of claim 19, further comprising, during the automated maintenance:
releasing the locking of the second cassette in the slider unit; and then
withdrawing the second cassette from the slider unit using the robot.
